(19) United States
(12) Patent Application Publication
(10) Pub. No.: US 2021/0297336 A1
(43) Pub. Date: Sep. 23, 2021

(54) SYSTEM AND METHOD FOR DETERMINING ONE OR MORE ACTIONS ACCORDING TO INPUT SENSOR DATA

(71) Applicants: Vinay B. RAMAKRISHNAIAH, Los Alamos, NM (US); Onur CAYLAK, Limburg (NL)

(72) Inventors: Vinay B. RAMAKRISHNAIAH, Los Alamos, NM (US); Onur CAYLAK, Limburg (NL)

(21) Appl. No.: 16/936,153

(22) Filed: Jul. 22, 2020

Related U.S. Application Data
(60) Provisional application No. 62/991,595, filed on Mar. 19, 2020.

(51) Int. Cl. H04L 12/26; G06N 20/00; G05B 23/02; G05B 13/04

(52) U.S. Cl. CPC H04L 43/50; H04L 43/0811; G05B 13/048; G05B 23/0254; G06N 20/00

(57) ABSTRACT

A preemptive system and method for determining one or more actions or stimuli according to input sensor data without explicit input from the user. The sensors are networked in an edge computing environment, which supports transmission and analysis of large amounts of data locally. Such an edge computing environment avoids the drawbacks of transmitting large amounts of data remotely. The edge computing environment is able to communicate remotely with a networked computer for further analysis assistance, for example for receiving previously trained AI models.

### FIELD OF THE INVENTION

The present invention relates to a system and method for determining one or more actions according to input sensor data, and in particular, to such a system and method that operate on a networked plurality of sensors to determine one or more actions.

### BACKGROUND OF THE INVENTION

IoT (Internet of Things) sensors are becoming more popular, as they enable sensor capabilities to be installed in a variety of environments. Furthermore, IoT also supports the physical separation of computational resources from such sensors, as the sensor data can potentially be transmitted to a remote location for analysis.

However, relatively few end to end solutions are currently available that incorporate such sensors. Such systems face a number of challenges. One issue is that IoT sensors can provide a large amount of data, but such data needs to be analyzed. The sensors alone are not very useful; rather a complete end to end system that includes data analysis is required. A number of such end to end systems are available for specific implementations, such as for monitoring a factory. However, flexible systems that can handle a wider variety of data types and analysis would be useful. Furthermore, such systems would also need to be able to handle large amounts of data which the sensors generate.

### BRIEF SUMMARY OF THE INVENTION

The present invention, in at least some embodiments, overcomes these drawbacks of the background art by providing a system and method for determining one or more actions according to input sensor data. The sensors are networked in an edge computing environment, which supports transmission and analysis of large amounts of data locally. Such an edge computing environment avoids the drawbacks of transmitting large amounts of data remotely. The edge computing environment is able to communicate remotely with a networked computer for further analysis assistance, for example for receiving previously trained Artificial Intelligence (AI) models.

The edge computing environment combines the sensor data from the plurality of sensors and analyzes it to determine one or more actions. The data analysis is performed by a data analysis engine, which preferably comprises an AI engine. The AI engine is preferably pretrained and received from the remote networked computer.

After the data has been analyzed, the analysis results are preferably fed to a system process engine, which matches the results to one or more system processes. These system processes are performed locally, and relate to causing one or more additional hardware and/or electromechanical devices to perform one or more actions. The additional hardware and/or electromechanical devices are preferably local to the edge computing environment. Optionally, the actions performed by these devices and/or the underlying data is provided remotely to a networked computer, for further analysis or for further actions to be performed.

The system process engine then causes the one or more additional hardware and/or electromechanical devices to perform one or more actions, preferably by instructing an action execution engine. This engine includes an interface to the one or more additional hardware and/or electromechanical devices to perform one or more actions. Preferably the engine also includes a state determination engine which is able to determine the state for each of the one or more additional hardware and/or electromechanical devices.

According to at least some embodiments, a data analysis engine and/or a system process engine learns the desired behaviors for the entire system, according to user manual actions and/or user requests, or according to environmental features. The system learns or is trained by observing the environment and reacting to stimuli which are changes in the environment. Optionally such learning occurs without a need for deliberate input from the user in the form of voice or gesture commands. The system can sift through observed data and identify patterns, initially with the help of the user, which will be automated as the system becomes familiar with the behavior of the user. For example, if a user would turn on lights in a room, say living room, every day after civil dusk, the system will eventually learn to automate this behavior.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a microprocessor or a microcontroller using any suitable operating system or firmware or a combination thereof. In any case, selected steps of the method and system of the invention could be described as being performed by a data processor, such as a computing platform for executing a plurality of instructions.

Unless otherwise defined, all technical and scientific terms used herein have the same meaning as commonly understood by one of ordinary skill in the art to which this invention belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involve performing or completing certain selected tasks or steps manually, automatically, or a combination thereof. Specifically, several selected steps can be implemented by hardware or by software on an operating system, of a firmware, and/or a combination thereof. For example, as hardware, selected steps of at least some embodiments of the disclosure can be implemented as a chip or circuit (e.g., ASIC). As software, selected steps of at least some embodiments of the disclosure can be implemented as a number of software instructions being executed by a computer (e.g., a processor of the computer) using an operating system. In any case, selected steps of methods of at least some embodiments of the disclosure can be described as being performed by a processor, such as a computing platform for executing a plurality of instructions. The processor is configured to execute a predefined set of operations in response to receiving a corresponding instruction selected from a predefined native instruction set of codes.

Software (e.g., an application, computer instructions) which is configured to perform (or cause to be performed) certain functionality may also be referred to as a “module” for performing that functionality, and also may be referred to a “processor” for performing such functionality. Thus, processor, according to some embodiments, may be a hardware component, or, according to some embodiments, a software component.

Further to this end, in some embodiments: a processor (or a microcontroller) may also be referred to as a module; in some embodiments, a processor may comprise one or more modules; in some embodiments, a module may comprise computer instructions—which can be a set of instructions, an application, software—which are operable on a computational device (e.g., a processor) to cause the computational device to conduct and/or achieve one or more specific functionality.

Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a thin client, a mobile communication device, a smart watch, head mounted display or other wearable that is able to communicate externally, a virtual or cloud based processor, a pager, and/or a similar device. Two or more of such devices in communication with each other may be a “computer network.”

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIG. 1 shows a non-limiting exemplary system for sensor data processing according to at least some embodiments;

FIG. 2 shows an exemplary input device in greater detail;

FIG. 3 shows a non-limiting exemplary implementation of data analysis engine 104, shown initially in FIG. 1;

FIG. 4 shows a non-limiting exemplary embodiment of the system process engine, shown initially in FIG. 1;

FIG. 5 shows a non-limiting exemplary embodiment of the action execution engine, shown initially in FIG. 1;

FIG. 6 shows a non-limiting exemplary embodiment of the storage, shown initially in FIG. 1;

FIG. 7 shows a non-limiting exemplary embodiment of the network interface, shown initially in FIG. 1;

FIG. 8 shows a non-limiting exemplary method for performing a plurality of processes at a server for training one or more models; and

FIG. 9 shows a non-limiting exemplary method for operation of the edge computational environment, shown initially in FIG. 1.

### DESCRIPTION OF AT LEAST SOME EMBODIMENTS

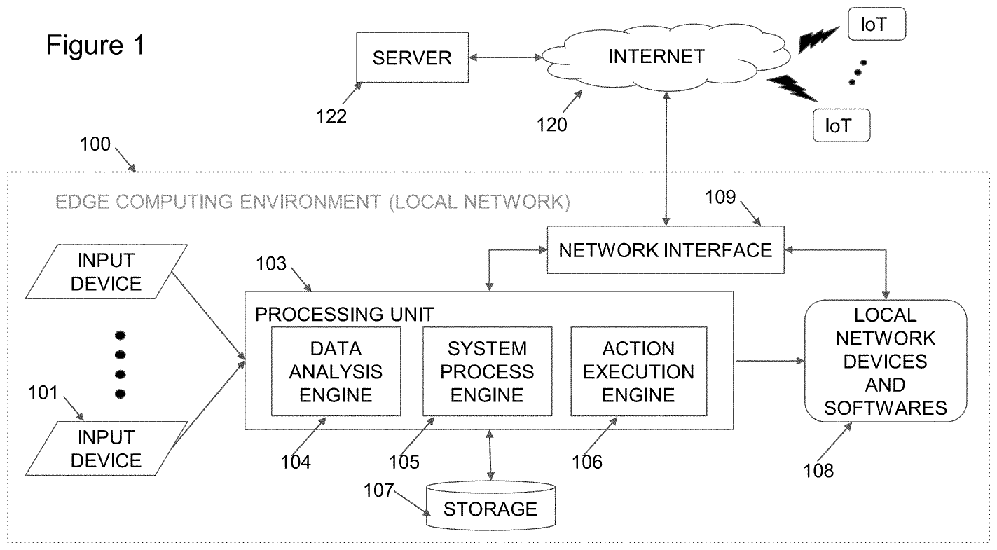

Turning now to the figures, FIG. 1 shows a non-limiting exemplary system 126. According to at least some embodiments, the present invention for supporting computing of local and edge computing devices. As shown, a system features an edge computing environment 100 in a local network, including a plurality of input devices 101, of which two are shown for the sake of illustration, feeding information into a processing unit 103. Edge computing environment 100 preferably handles input from, and output to, external devices. As shown, input devices 101 provide sensor information about the state of the external world. Edge computing environment 100 then processes this information to provide actionable output to a network interface 109, for communication to devices on an external network, and also to locally networked devices and optionally software modules, shown as 108.

Processing unit 103 communicates with a storage 107 for storing information. Processing unit 103 also communicates optionally with the network interface 109. Network interface 109 may also optionally communicate with external devices that are external to edge computing environment 100, including but not limited to the server 122 and one or more IoT or internet of things devices, shown as 124A and 124B for the sake of illustration, only without intention of being limiting. These devices, external to edge computing environment 100, communicate with edge computing environment 100 through a computer network such as the internet, 120.

Within edge computing environment 100, as shown, processing unit 103 features a data analysis engine 104, a system process engine 105 and an action execution engine 106. Information is received from input devices 101 to processing unit 103 and is analyzed by data analysis engine 104. Data analysis engine 104 receives raw format data from input devices 101, and then converts it into something that can be processed.

System process engine 105 receives the processable data from data analysis engine 104. System process engine 105 then determines the processing that is to be performed and then passes off any necessary information including optionally any actions performed to action execution engine 106. System process engine 105 also optionally stores information such as the action taken, whether an action was taken, the data analysis and so forth in storage 107. Optionally storage of raw data is maintained locally at storage 107, rather than remotely through internet 120, for data privacy and security.

For example, input device 101 may comprise a camera to look into a room and then determine whether the lights should be on or off. For example, the lights may need to be turned off after the room has been empty of people for a specified period of time. Once that time elapses, system process engine 105 determines the correct interpretation of data from the environment around it, and then determines an appropriate action.

Action execution engine 106 may then communicate with local network devices and software 108 in order to execute the action but may also optionally execute the action through the previously described external devices that are external to edge computing environment 100 by communication through network interface 109 and then through internet 120. For example, action execution engine 106 may determine that lights should be turned on or off, according to commands received from system process engine 105 regarding the correct state of the lights.

Optionally, if a balance between inputs from various input devices 101 is required, then data analysis engine 104 determines the correct balance. The data from input devices 101 may have different formats or characteristics. For example and without limitation, the data may be numerical data (pressure sensor, microphone, etc.), categorical data (liquid sensor determining a state of “wet” or “not wet”, etc.), or image data (IR (infrared), Radar/Lidar, Camera, etc.). These inputs are preferably processed differently. For example, numerical and categorical data is preferably processed by using multi-layered perceptron or dense networks. On the other hand, image data is better processed by a CNN (convolutional neural network). These inputs are preferably digested, combined, and further analyzed, for example by using an LSTM (long short term memory) neural net model for context detection.

For example, data analysis engine 104 may be implemented as a multiprocessor which can use multiple threads, and then each thread can accept input, or a plurality of threads can accept inputs from certain input devices, and then do context switching. However, for combining the interpretation of a plurality of different input pieces of information—for example, whether a person is in a room and also whether that person is authorized to be in the room (according to RFID or face recognition, or another type of identifying technology)—preferably such combinations are handled by system process engine 105. As described in greater detail below, system process engine 105 may operate according to a rules based engine, in which input causes one or more rules to be invoked, or through AI (artificial intelligence) or ML (machine learning) algorithms. For the latter, logistic regression, some of type LSTM (long short term memory) model or another type of model may be employed.

Optionally, data analysis engine 104 and/or system process engine 105 learns the desired behaviors for the entire system, according to user manual actions and/or user requests, or according to environmental features. The system learns or is trained by observing the environment and reacting to stimuli which are changes in the environment. Optionally such learning occurs without a need for deliberate input from the user in the form of voice or gesture commands. The system can sift through observed data and identify patterns, initially with the help of the user, which will be automated as the system becomes familiar with the behavior of the user. For example, if a user enters their kitchen, say at evening before dinner, the system can provide cooking recipes based on ingredients in their smart fridge or suggest takeout options.

In addition to the above, the processing unit 103 also features a processor and a memory (not shown), where the processor is configured to execute a predefined set of operations in response to receiving a corresponding instruction selected from a predefined native instruction set of codes. These codes comprises: a first set of machine codes selected from the native instruction set for receiving raw data from input devices 101, a second set of machine codes selected from the native instruction set for transmitting raw data to and activating the data analysis engine 104 to analyze the raw data, a third set of machine codes selected from the native instruction set for transmitting analyzed data to and activating the system process engine 105 to determine the correct interpretation of data from the environment around the data and the appropriate action, and a fourth set of machine codes selected from the native instruction set for activating the action execution engine 106. Each of the first, second, third, and fourth sets of machine codes is stored in the memory.

This native instruction set of codes may be used as other functions as described wherein: a fifth set of machine code selected from the native instruction set for transmitting and receiving data from the storage 107, and sixth set of machine codes selected from the native instruction set for communicating with the network interface 109. Each of the fifth and sixth sets of machine codes is stored in the memory.

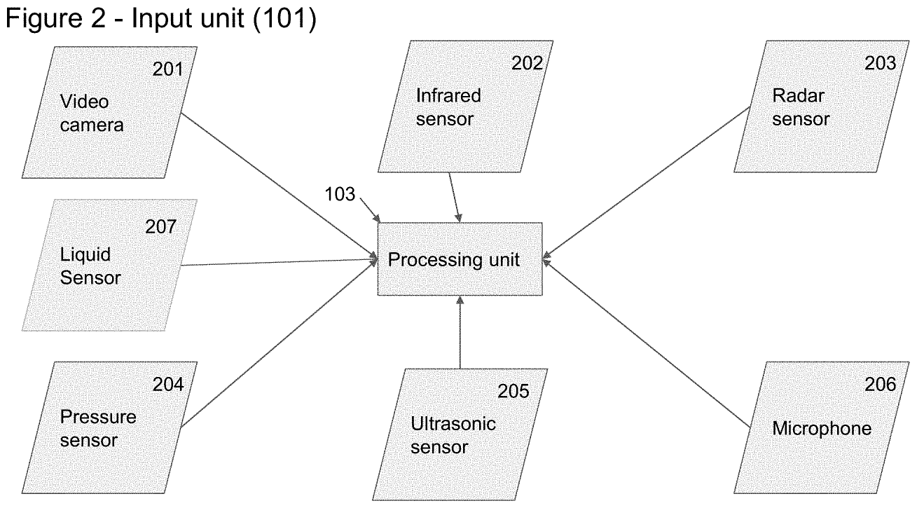

FIG. 2 shows an input device 101 in greater detail. Shown optionally as a plurality of input devices 101, including without limitation a video camera 201, infrared sensor 202, a radar sensor 203, pressure sensor 204, ultrasonic sensor 205, microphone 206, a liquid sensor 207. Video camera 201 optionally obtains any type of RGB (red, green, blue) data or alternatively may comprise a depth camera, such as a TOF (time of flight) camera.

Infrared sensor 202 preferably senses infrared radiation and may also work in combination with video camera 201. A radar sensor 203 may be used to sweep the area for motion or for radar to determine presence of various objects. Pressure sensor 204 obviously detects barometric pressure. An ultrasonic sensor 205 detects proximity and levels with high reliability. An ultrasonic transducer sends ultrasonic sound waves and reads reflections to analyze distinct echo patterns, which may be used for understanding three dimensional patterns. Based on the type of ultrasonic sensor used, 3D imaging is also possible. Microphone 206 detects audio data such as ambient sounds. Liquid sensor 207 may detect the presence of moisture, for example, or may also detect the presence of a large amount of liquid. All of these sensor inputs are preferably fed into processing unit 103 as previously described.

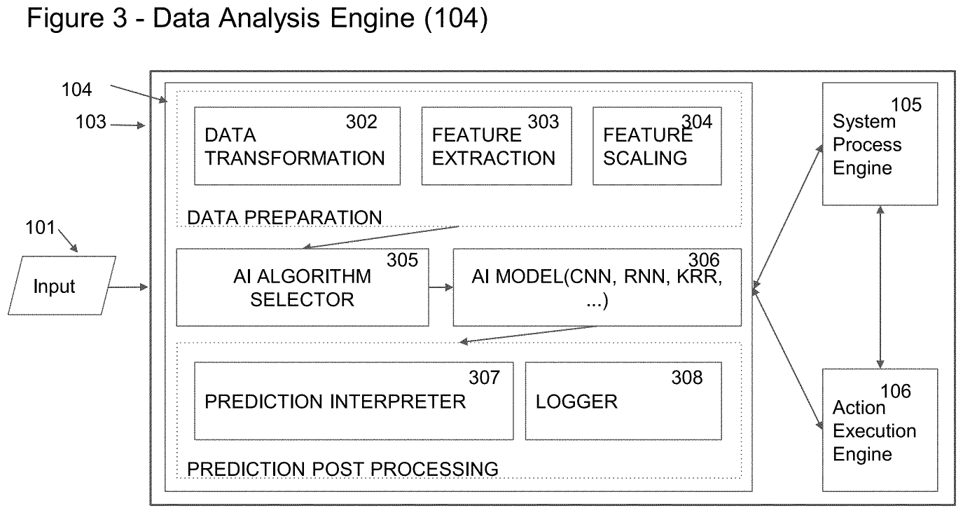

FIG. 3 shows a non-limiting exemplary implementation of data analysis engine 104, shown initially in FIG. 1. As shown in FIG. 3, data analysis engine 104 preferably receives input through one or more input devices 101. Data analysis engine 104 is then contained within the previously described processing unit 103. Also, as shown for the sake of discussion only with no intention of being limiting, within data processing unit 103, system processing engine 105 and execution engine 106 are shown schematically.

Turning back to data analysis engine 104, preferably the data is initially prepared through a data preparation block. This block preferably includes a data transformation block 302 for transforming the data to a usable form. Initially, the raw data is preferably transformed in order to support extraction of the feature. For example, video camera data is provided as a plurality of frames or images. Each such frame is a matrix, which needs to be transformed to a vector or other format which can support feature extraction. For images, various feature extraction methods are known in the art, including but not limited to Scale-Invariant Feature Transform (SIFT) and Speeded Up Robust Features (SURF). A combination of these methods is described with regard to images obtained of the outdoor (external to a building) environment in Valgren, C., Lilienthal, A J. (2007): SIFT, SURF and seasons: long-term outdoor localization using local features; in: ECMR 2007: Proceedings of the European Conference on Mobile Robots (pp. 253-258).

A feature extraction block 303, for extracting one or more features from the data. Such feature extraction may be done with an AI (artificial intelligence) or machine learning algorithm, or may be done according to another process as is known in the art. Then feature scaling 304 scales the features appropriately, for example, to make certain that one feature is not over represented or to determine the relative weight of each feature, or to handle rotations and other manipulations of the sensor data. Feature scaling is employed for data processing in the normalization of independent values. If the range or variance of one of the features is large, it dominates other features that can provide important information. Feature scaling supports normalization, for example through Gaussian with zero mean and unit variance, for numerical and categorical features, so they contribute proportionally.

Feature scaling may for example handle rotations of images for a neural network, or differently scaled objects. Such scaling for images may be performed for example with a Gaussian blur after feature extraction, such that scaling may be handled through different levels of Gaussian blurs and extrapolations.

After data preparation, the information is then fed into an AI algorithm selector 305, which determines the appropriate AI algorithm and model to be executed. Such selection may, for example, depend upon the type of data received, such as image data or audio data. Once the selection has been made, it is sent to an AI model 306, which may include any type of AI or machine learning model or algorithm, including but not limited to an RNN (recurrent neural network), CNN (convolutional neural network), DBN (deep belief network), KRR (kernel ridge regression) and so forth. The selection of the model preferably relates to the context of the combination of data inputs received, according to the input conditions. For example, video cameras may not be useful at night, whereas ultrasonic/radar sensors will still continue to function normally. The latter sensors are active transducers and so are not dependent on ambient energy (for example, sunlight). In certain other cases, like environments with high radio interference, radar sensor input may be less useful. Depending on the type of sensor and the type of input (numerical, categorical or image), different types of AI algorithms are preferably employed for processing. The AI algorithm selector weighs the outputs of AI algorithms depending on the input. The AI model is responsible for assimilating the pre-conditioned input and making intelligent decisions, not limited to tasks such as digital assistant, patient monitoring, etc.

The output is then provided to a prediction interpreter 307 which determines the interpretation of the data and predicts which actions should occur. Prediction interpreter 307 may for example be implemented through a rules based engine, according to the determination of an output by the AI or ML algorithm. A logger 308 proceeds to log the action, preferably including the metadata relating to the previous data and analysis, and the suggested action. This action is preferably performed as a prediction post-processing, as the answer provided by the AI machine learning model must then be translated into some kind of interpretation that the system is able to act upon.

This interpretation is then preferably provided to a system process engine 105, which may also provide feedback to the AI algorithm selector, 305, and also may provide feedback and retraining to AI model 306 and is also provided to action execution engine 106, again, which may provide feedback into the AI segment of data analysis engine 104 to improve the performance of the AI model or machine learning algorithm.

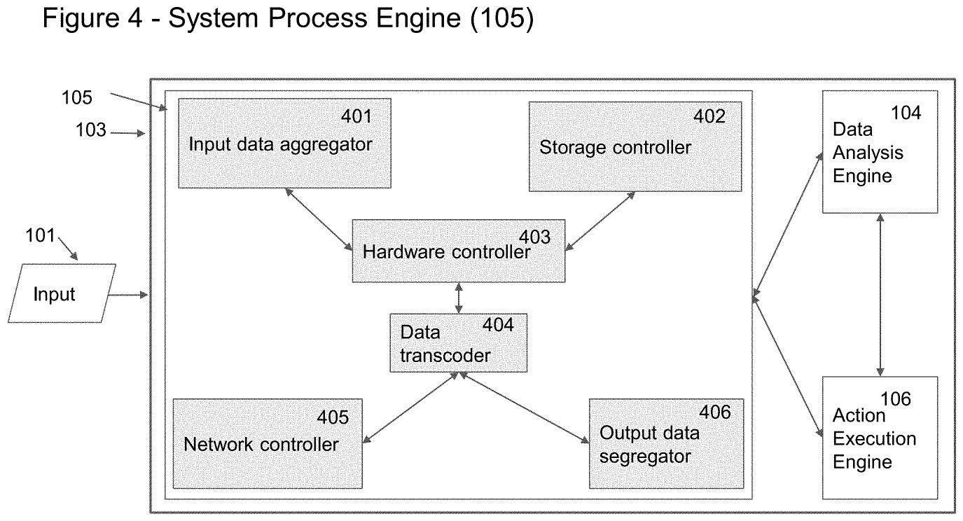

FIG. 4 shows a non-limiting exemplary embodiment of system process engine 105, which is again shown in the context of processing unit 103, with data analysis engine 104 and execution engine 106 shown schematically. Again, input is provided by one or more preferably a plurality of applied input devices 101 to processing unit 103.

System process engine 105 preferably receives information such as the analysis of the data from data analysis engine 104, as previously described. System process engine 105 preferably initially begins with an input data aggregator 401, which may be used to input a plurality of different data points or data analysis points from data analysis engine 104 and may also retrieve information from a storage controller 402. These two inputs are fed to a hardware controller 403, which feeds the information then to a data transcoder 404. This in turn can determine which action needs to be performed and how it may be performed by providing information to a network controller 405 and also to an output data segregator 406.

Optionally, system process engine 105, may for example, through network controller 405, communicate directly as previously described with one or more external devices. These may be external to the edge computing block 100 as previously described or simply external to processing unit 103. Alternatively and optionally or optimally also sequentially or simultaneously, output data segregator 406 proceeds to provide actions to be executed to action execution engine 106.

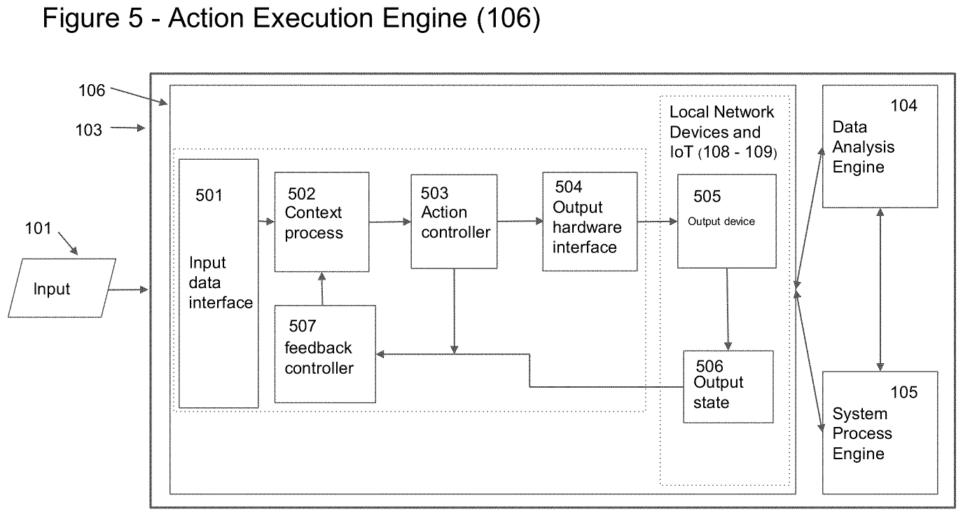

FIG. 5 shows a non-limiting exemplary embodiment of action execution engine 106, again within the context of processing unit 103, data analysis engine 104 and system process engine 105 represented schematically. Data is again received from one and preferably a crowd of input devices 101. Action execution engine 106 preferably includes an input data interface 501 for receiving input commands from system process engine 105 and then it determines the context with the context processor 502. Context processor 502 then feeds information to an action controller 503, which then decides which actions to be performed, which is sent to an output hardware interface 504.

This may then be sent to output devices 505, for example, in the context of local network devices and IoT (internet of things) devices 108 to 109. Such information preferably also determines an output state 506. Feedback may be provided to data analysis engine 104 and system process engine 105. In addition, feedback from output state 506 is preferably fed to feedback controller 507, which then feeds back to context processor 502, for example, to determine which actions were executed successfully and whether adjustments need to be made.

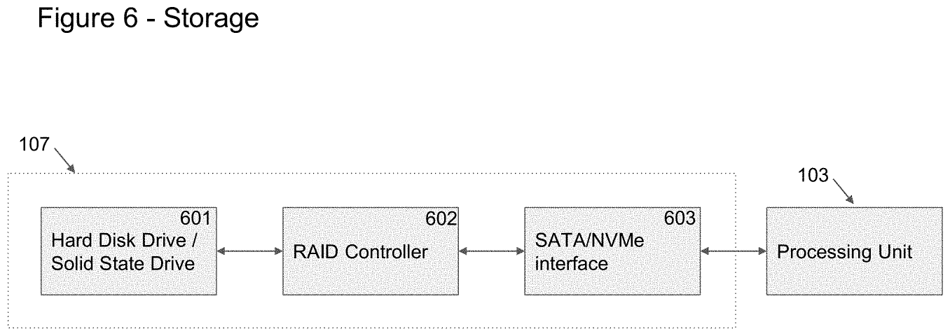

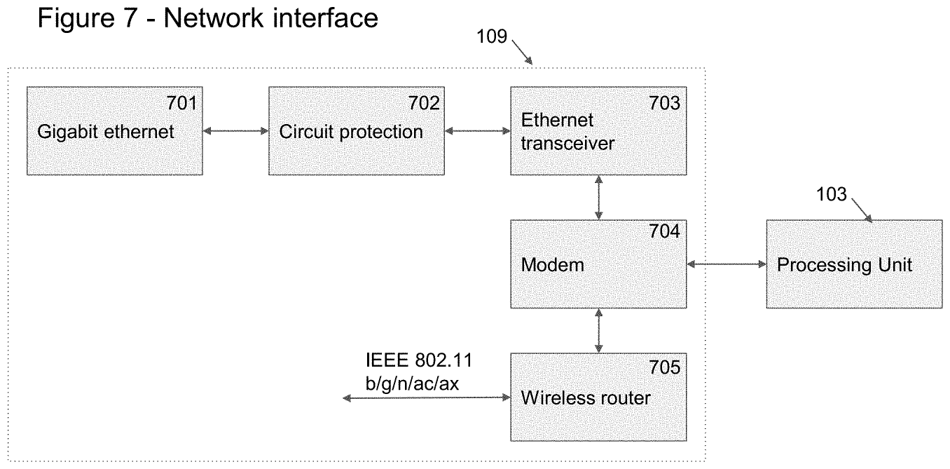

Storage 107 is shown in greater detail in FIG. 6. As shown, storage 107 may include a hard disk drive or solid state media 601 in combination with the RAID controller 602 and then the appropriate interface 603 to processing unit 103. Network interface 109 which was previously described in FIG. 1, may be used to communicate between edge computing environment 100 and one or more external devices, is shown in greater detail in a non-limiting exemplary FIG. 7.

As shown in FIG. 7, network interface 109 preferably includes a gigabit ethernet 701, circuit protection 702, and an ethernet transceiver 703. This latter component is in communication with modem 704 for internet connectivity. Instead, the network interface can be wireless, including with a wireless router 705 that connects to a modem 704. The network interface 109 is connected to the processing unit 103 either using a wired or wireless connection.

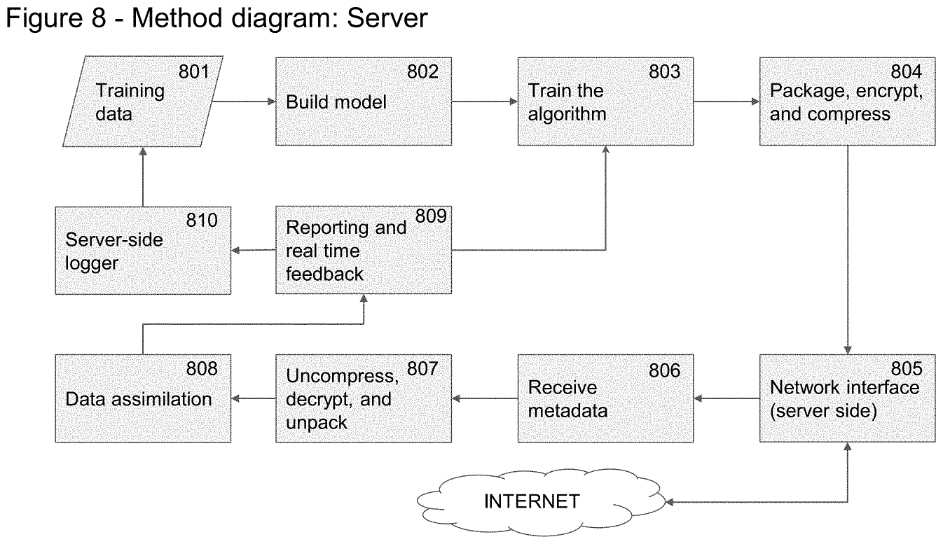

FIG. 8 shows a non-limiting exemplary method for performing a plurality of processes at a server (or another computational device) for training one or more models. The externally provided server preferably performs the training and then sends the model back down to the processing unit 103 and more particularly, preferably to the data analysis engine 104. As shown in this non-limiting exemplary training method, a server initially receives training data at 801 and then proceeds to build the model at 802. It may optionally build a bespoke model or may choose from a selection of prebuilt models.

For example, for building as opposed to selecting a model, the problem is preferably categorized, based on the functionality that is being added and/or improved. The algorithm selection depends on input and output data, and the type of analysis and processing required. Depending on the data needs, different available options can be considered and weighted based on accuracy, complexity, scalability, etc. Optionally, manual human input is employed to assist in the weighting process. Once the model is selected, the hyper-parameters are tuned for the particular problem case.

Next, the algorithm is trained at 803 and the data is package encrypted and compressed at 804. This information is then fed to the network interface at 805, which it then communicates through the internet with the local system (processing unit 103), not shown. The processing unit 103 also preferably provides information through the network interface 805, for example regarding feedback. This feedback is provided then as metadata at 806. It is uncompressed, decrypted and unpacked at 807, and is then preferably incorporated at 808.

This feedback is then used to compare the real time performance of the model with the trained performance. This, for example, will be provided through reporting in real-time feedback module 809 and then through a server-side logger 810. The data may then be used to retrain the algorithm at 803 and may also be provided as initial training data 801, for example, for a new or newly selected prebuilt model.

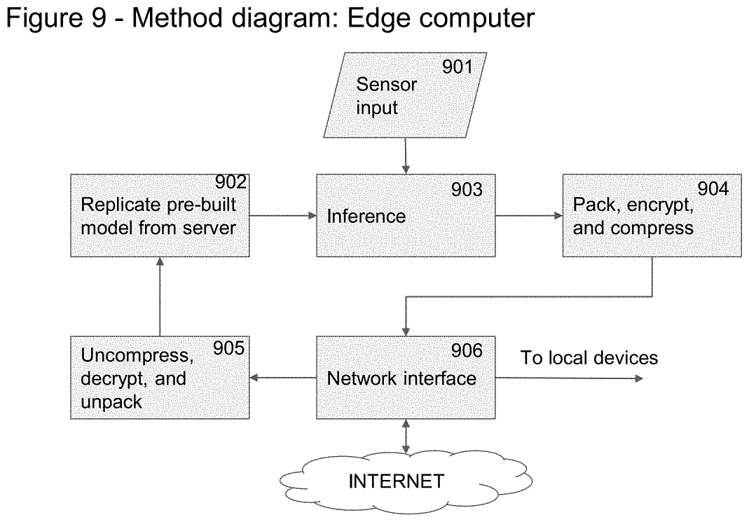

FIG. 9 shows a non-limiting exemplary method for operation of the edge computational environment shown as 100 in FIG. 1. As shown in FIG. 9, the edge computing environment preferably receives sensor input at 901 and then performs an inference at 903. Inference at 903 is preferably performed by the prebuilt model from the server at 902. Prebuilt and preferably also pre-trained. Then the output is packed, encrypted and compressed at 904 and is sent through network interface 906, for example, as commands to local devices, but also may be sent back through the internet, back to the server for training.

Further data and models may be received through the internet also at network interface 906, which can be uncompressed, decrypted and unpacked at 905 and may then be used to replicate the prebuilt and pre-trained model at 902, after which the process preferably continues.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for effecting at least one local action through a local network, the system comprising a plurality of sensors and an edge computing environment, wherein said edge computing environment receives input data from the plurality of sensors, said edge computing environment further comprising a processing unit, said processing unit comprising a data analysis engine and a system process engine, wherein said data analysis engine combines the sensor data from the plurality of sensors to determine one or more analysis results, and wherein said system process engine matches said analysis results to one or more system processes, such that one or more actions are performed according to said one or more system processes.

2. The system of claim 1, wherein said edge computing environment further comprises one or more additional hardware and/or electromechanical devices.

3. The system of claim 2, wherein said data analysis engine further comprises an AI engine for combining the sensor data to determine said analysis results.

4. The system of claim 3, wherein said AI engine further comprises a feature extraction module and a feature scaling module, such that said input data is preprocessed to first extract features and then to scale said features before further analysis.

5. The system of claim 4, wherein said AI engine further comprises an AI selector and a plurality of AI models, and wherein at least one AI model is selected by said AI selector according to said combined sensor data.

6. The system of claim 5, wherein said AI engine further comprises a prediction interpreter for interpreting said analysis of said combined sensor data to determine one or more predicted actions.

7. The system of claim 6, further comprising a remote computational device connected through the network to said edge computing environment, wherein one or more AI models are pre-trained by said remote computational device and are then transmitted to said AI engine.

8. The system of claim 7, wherein said processing unit further comprises an action execution engine, wherein said action execution engine comprises an interface to the one or more additional hardware and/or electromechanical devices, for instructing said devices to perform one or more actions according to one or more instructions from said system process engine.

9. The system of claim 8, wherein said action execution engine further comprises a state determination engine for determining the state for each of the one or more additional hardware and/or electromechanical devices.

10. The system of claim 9, wherein said edge computing environment is local to said sensors and additional hardware and/or electromechanical devices, such that said edge computing environment is co-localized to said sensors and said additional hardware and/or electromechanical devices.

11. The system of claim 11, wherein said data analysis engine and/or said system process engine learns the desired behaviors for the entire system, according to user manual actions and/or user requests, or according to environmental features.

12. A system for remotely training an AI model for execution in an edge computing environment, the system comprising a remote computational device for training the AI model and a remote network for communicating with said remote computational device and the edge computing environment, the edge computing environment comprising a network, a processing unit, a plurality of sensors and one or more additional hardware and/or electromechanical devices, wherein said processing unit, said plurality of sensors and said additional hardware and/or electromechanical devices communicate through said network, and wherein said AI model is transmitted from said remote computational device to said processing unit, such that said processing unit receives input data from said plurality of sensors, analyzes said data with said AI model and instructs said additional hardware and/or electromechanical devices to perform one or more actions according to said analysis.

13. A system for effecting at least one local action through a local network, the system comprising a plurality of sensors and an edge computing environment, wherein said edge computing environment receives input data from the plurality of sensors, said edge computing environment further comprising a processing unit, said processing unit comprising a data analysis engine, a system process engine, an action execution engine, a processor, and a memory, wherein said data analysis engine combines the sensor data from the plurality of sensors to determine one or more analysis results, and wherein said system process engine matches said analysis results to one or more system processes, such that one or more actions are performed according to said one or more system processes, wherein said processor is configured to execute a predefined set of operations in response to receiving a corresponding instruction selected from a predefined native instruction set of codes, said codes comprising:
a first set of machine codes selected from the native instruction set for receiving raw data from the plurality of sensors,
a second set of machine codes selected from the native instruction set for transmitting raw data to and activating the data analysis engine to analyze the raw data,
a third set of machine codes selected from the native instruction set for transmitting analyzed data to and activating the system process engine to determine the correct interpretation of data from the environment around the data and the appropriate action,
a fourth set of machine codes selected from the native instruction set for activating the action execution engine 106, and
where each of the first, second, third, and fourth sets of machine codes is stored in the memory.

14. The system of claim 13, wherein said edge computing environment further comprises one or more additional hardware and/or electromechanical devices.

15. The system of claim 14, wherein said data analysis engine further comprises an AI engine for combining the sensor data to determine said analysis results, wherein said AI engine further comprises a feature extraction module and a feature scaling module, such that said input data is preprocessed to first extract features and then to scale said features before further analysis.

16. The system of claim 15, wherein said AI engine further comprises an AI selector and a plurality of AI models, and wherein at least one AI model is selected by said AI selector according to said combined sensor data.

17. The system of claim 16, wherein said AI engine further comprises a prediction interpreter for interpreting said analysis of said combined sensor data to determine one or more predicted actions.

18. The system of claim 17, further comprising a remote computational device connected through the network to said edge computing environment, wherein one or more AI models are pre-trained by said remote computational device and are then transmitted to said AI engine.

19. The system of claim 18, wherein said action execution engine comprises an interface to the one or more additional hardware and/or electromechanical devices, for instructing said devices to perform one or more actions according to one or more instructions from said system process engine.

20. The system of claim 19, wherein said action execution engine further comprises a state determination engine for determining the state for each of the one or more additional hardware and/or electromechanical devices.
